(19) United States
(12) Patent Application Publication
(10) Pub. No.: US 2006/0144185 A1
(43) Pub. Date: Jul. 6, 2006

(54) Shift-positioning structure of gear case

(76) Inventor: Feng-Chun Tsai, Taoyuan (TW)

Correspondence Address: LEONG C LEI, PMB # 1008, 1867 YGNACIO VALLEY ROAD, WALNUT CREEK, CA, 94598, US

(21) Appl. No.: 11/026,024

(22) Filed: Jan. 3, 2005

(51) Int. Cl. G05G 5/06

(52) U.S. Cl. 74/527

(57) ABSTRACT

A dual positioning shift-adjustment structure of the gear case of electrical tools is provided. The dual positioning shift-adjustment structure contains a spring band structure and a spring steel beads structure, which make accurate, precise, and no-gap position of the gearshift. It makes shift-positioning of the torque-driven electrical tool a perfect operation and improves both operational life and quality of end products of electrical tools.

### BACKGROUND OF THE INVENTION

(a) Technical Field of the Invention

The present invention generally relates to shift-positioning structure of a gear case, and more particularly to a shift-adjustment structure with dual positioning feature that can fix problems encountered in prior arts.

(b) Description of the Prior Art

Electrical tools include electrical drills, electrical manual tools, electrical screw drivers, electrical screw-removers etc. All these tools combine the mechanism of decelerating gear case and electrical motor to perform drilling, screwing, or other types of action on the object needing these works. The torque and tuning speed vary depending on the material and hardness of the object to be worked on in order to assure a smooth operation. Most of the electrical tools use a clutch to adjust the torque's magnitude. Turing the outer mantle of a clutch will apply pressure against the spring inside in stepping action which controls the required torque and dynamic force. This invention is a gearshift structure of the outer mantle of a turning clutch to assure precise shift position for generating the designated torque.

The shift-positioning structure of the outer mantle of a turning clutch in current electrical tools is shown in FIG. 1. A single concave spring band A3 is installed between the outer mantle of a turning clutch A1 and the inner shift gear A2 for positioning the shift. Turning the outer mantle can adjust space between the spring band A3 and the shift gear A2 in a stepping motion to drive the torque mechanism for desired shift positions.

With the above description the deficiencies of prior arts can be easily identified:

First, current tools use only a single spring band to position the shift making the driving force rather weak. If one compensates this weak driving force by increasing the thickness of the spring band, the move will decrease the elasticity and diminish the deformation ability of the spring band which causes the clutch to become stiff and difficult to handle. It will also make the shift more difficult to reach the accurate position required.

Secondly, current tools use a concave spring band to position the shift. The shape and size of the concaveness is the base of how good a fit the inner shift gear and the spring band can make. The lack of precise fit will cause a gap between the two making the outer mantle of the turning clutch A1 to operate in a slightly unsteady manner. This effect will severely affect the positioning of the shift in the outer mantle A1.

Thirdly, this unsteady operation of the outer mantle of the turning clutch A1 will make shift positioning difficult, uncertain, or inaccurate. All these can cause the shift to slide out of position or end up in a wrong position.

Fourthly, a loose outer mantle of the turning clutch A1, as a result of the aforementioned inaccurate shift position, will create an abnormal operation and rough handling of the tool. This effect may cause inferior quality in objects worked on by these tools. This will ultimately affect the tools' competitiveness on the market.

Finally, following what is stated in item 4, loose outer mantle of the turning clutch A1 will accelerate the tearing and wearing between the spring band A3 and the shift gear A2, which shortens the tool's operational life. In summary, prior arts have aforementioned design deficiencies which will result in poor quality of their end products. These deficiencies are being addressed in this invention.

### SUMMARY OF THE INVENTION

The primary purpose of the present invention is to provide an improved shift-positioning structure for gear case of electrical tools. The structural mechanism deployed in this invention guarantees no gap will be formed in gearshift to assure accurate, precise, and sliding-free shift position in achieving high operational efficiency of electrical tools. The advantage and characteristics of this invention are:

First, the dual positioning mechanism of this embodiment combines the spring band and spring steel beads designs to obtain the synergy effect for a superior shift-positioning structure.

Secondly, due to the characteristic of rigid metallic elasticity, the spring band deforms slightly under pressure generating a stepping movement to make the shift reach its desired position.

Thirdly, the spring steel beads structure comprises a set of steel beads and a tension spring. The steel beads match each gearshift, and the tension spring keeps a fixed expansion force with its spring inertia. The later effect assures the steel beads will fit into each gear teeth when pressed. With this design, the present embodiment avoids the said unsteady operation caused by gap resulted from inaccurate positioning.

Fourthly, with this embodiment the quality of electrical tools is improved, and its operational life is extended. Consequently, the present invention will enhance the competitiveness of electrical tools on the market.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top view showing the shift-positioning structure of the outer mantle of a turning clutch of electrical tools designed with prior arts.

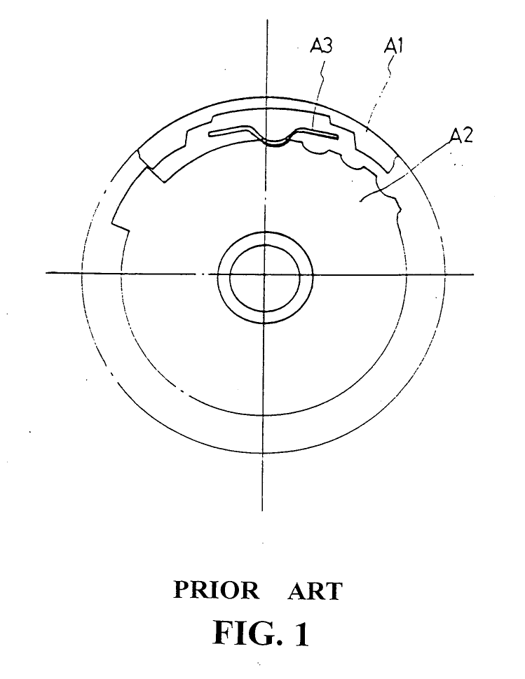

FIG. 2 is a three-dimensional view showing present embodiment's structure.

FIG. 3 is a sectional view showing each element of the present embodiment.

FIG. 4 is the cross-sectional view showing the entire structure of the present embodiment.

FIG. 5 is the top view showing the entire structure of the present embodiment.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The following detailed description along with the accompanied drawings can explain fully preferred embodiments of the present invention.

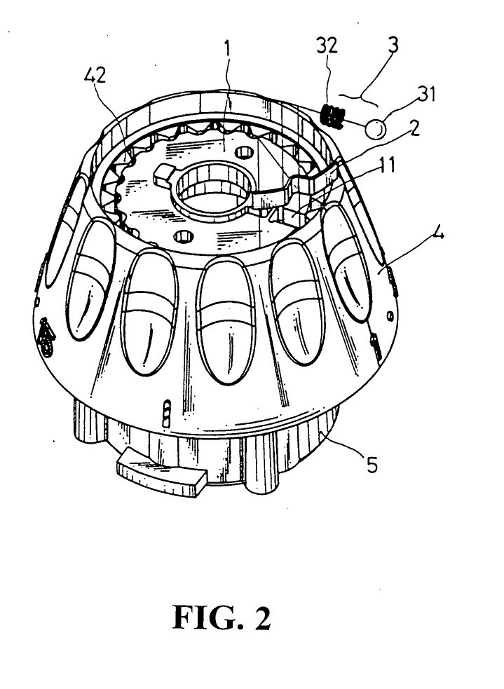

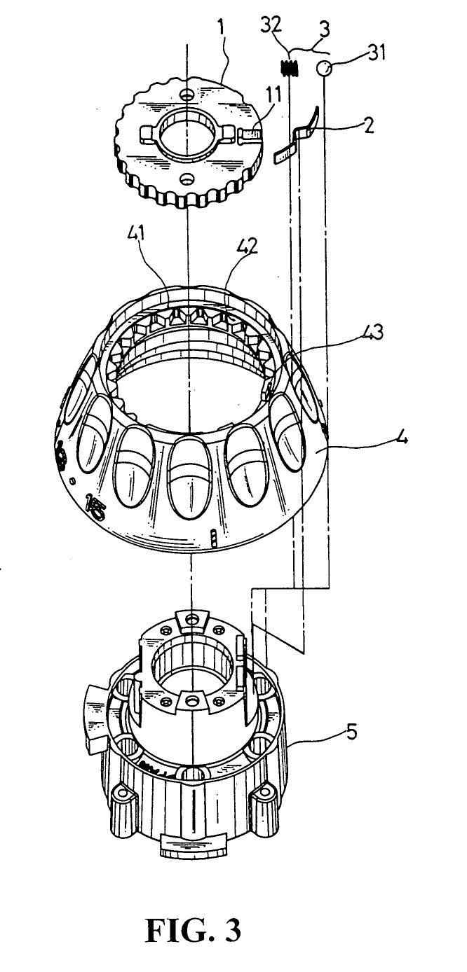

As shown in FIGS. 2 and 3, the entire structure of the present embodiment comprises of elements of a gearshift catching teeth 1, a positioning spring band 2, a set of shift-positioning steel spring beads 3, an outer mantle of clutch 4, and a gear case housing 5. The gearshift catching teeth 1 is placed on the top ream 41 at the outer mantle of clutch 4, and it is also connected with the gear case housing 5 which is inserted from the bottom making all three a one-piece structure. This embodiment enables the dynamic force to be transmitted from the gear case housing 5. These FIGURES do not show the gear axel for transmitting the force. The outer mantle of clutch 4 and the gearshift catching teeth 1, the positioning spring band 2 and the set of shift-positioning steel spring beads 3 make up the main mechanisms of the torque driven shift-positioning feature of the present invention.

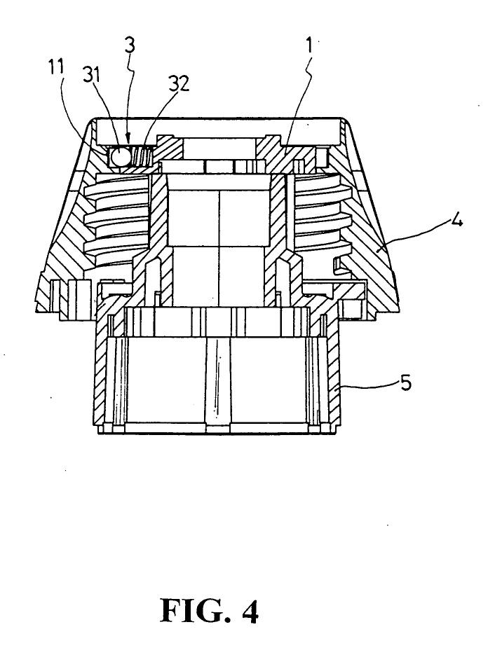

Next as show in FIG. 4 and FIG. 3, there is a slot 11 on the outer edge of the gearshift catching teeth 1; its size is such that the set of shift-positioning steel spring beads 3 can be fitted inside the slot placing the steel spring beads 31 at the outer edge and the tension spring 32 at the inside of the slot 11. The steel spring beads 31 is always fitting snugly with the catching gear teeth 42 on the outer mantle of clutch 4. As shown in FIG. 2, the positioning spring band 2 is in the shape of a convex double-wing structure and can be fitted between the top ream 41 and the catching gear teeth 42 of the outer mantle of clutch 4 with the convex side of the positioning spring band 2 facing outward. This mates it against gearshift catching teeth 1 for positioning the shift.

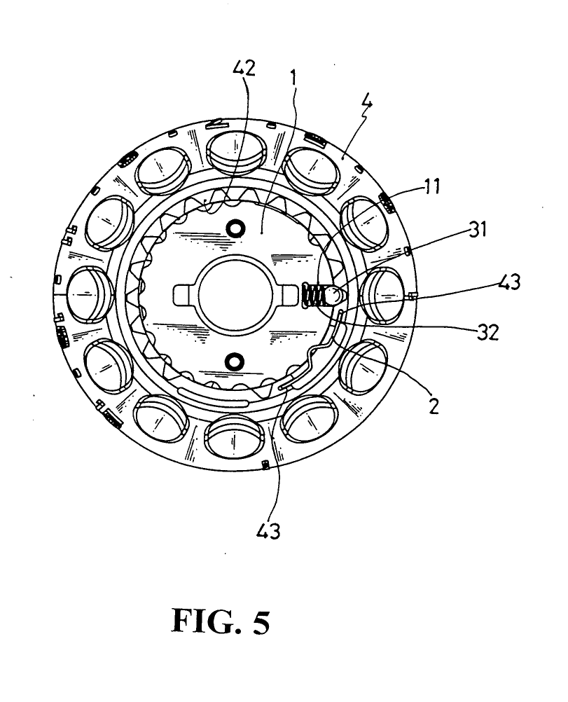

As shown in FIG. 5, the spring band 2 and the set of steel spring beads 3 are in an opposing-face position for a two-way positioning structure in controlling the gearshift's position. The mating object of the positioning spring band 2 is the gearshift catching teeth 1; the set of shift-positioning steel spring beads 3 is the catching gear teeth 42. The pattern of opposite-direction positioning will assure the mating of the gearshift catching teeth 1 against the outer mantle of clutch 4 at all time. At the same time, this embodiment also assures there is no gap between the catching gear teeth 42, and the steel spring beads 31 inside the outer mantle of clutch 4, preventing the unsteady movement caused by positioning gap in the outer mantle of clutch 4.

With this foregoing description the present invention is indeed a superior design comparing to the prior arts. It is an innovative design with improved functionality.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved shift-positioning structure comprising a gearshift catching teeth, a positioning spring band, a set of shift-positioning steel spring beads, an outer mantle of clutch, and a gear case housing;
said gearshift catching teeth having a slot being placed on the top ream at said outer mantle of clutch and connected with said gear case housing to make all three a one-piece structure;
said positioning spring band being metallic with rigid elasticity and in the shape of a convex double-wing structure;
said set of shift-positioning steel spring beads comprising a set of steel beads and a tension spring;
said outer mantle of clutch comprising a top ream, catching gear teeth, and a shallow matching slot;
said gear case housing transmitting dynamic force through a gear axel;
said shift-positioning steel spring beads being fitted at the outer edge of said slot and said tension spring being fitted at the inside of said slot;
said steel spring beads being always fitted snugly with said catching gear teeth on said outer mantle of clutch; and
said gearshift catching teeth, said positioning spring band, said set of steel spring beads, and said outer mantle of clutch making up the torque driven shift-positioning mechanism of the present invention.
